(19) United States
(12) Patent Application Publication
(10) Pub. No.: US 2011/0151875 A1
(43) Pub. Date: Jun. 23, 2011

(54) HANDOVER TERMINAL AND METHOD FOR RECEIVING BROADCAST DATA IN BROADBAND WIRELESS ACCESS SYSTEM, AND METHOD FOR PROVIDING INFORMATION OF SERVING BASE STATION

(75) Inventors: Chul PARK, Daejeon (KR); Sang Ho LEE, Daejeon (KR); Yeong Jin KIM, Daejeon (KR)

(73) Assignee: Electronics and Telecommunications Research Institute, Daejeon (KR)

(21) Appl. No.: 12/971,912

(22) Filed: Dec. 17, 2010

(30) Foreign Application Priority Data
Dec. 17, 2009 (KR) 10-2009-0126299
Apr. 20, 2010 (KR) 10-2010-0036548

(51) Int. Cl. H04W 36/00

(52) U.S. Cl. 455/436

(57) ABSTRACT

A mobile communication apparatus is provided. The mobile communication apparatus includes an information receiver to receive, from a serving base station, target base station information corresponding to at least one target base station located in a neighboring cell, and a controller to examine the target base station information and to perform a handover to the at least one target base station based on whether the at least one target base station supports a multi-band, and whether the at least one target base station provides a broadcast service.

### CROSS-REFERENCE TO RELATED APPLICATIONS

This application claims the benefit of Korean Patent Application No. 10-2009-0126299 and of Korean Patent Application No. 10-2010-0036548, respectively filed on Dec. 17, 2009 and Apr. 20, 2010, in the Korean Intellectual Property Office, the disclosures of which are incorporated herein by reference.

### BACKGROUND

1. Field of the Invention

The present invention relates to a mobile communication apparatus and a handover method of the mobile communication apparatus, and an information providing method of the serving base station that may receive broadcast data in a broadband wireless access system. More particularly, the present invention relates to a mobile communication apparatus and a handover method of the mobile communication apparatus, and an information providing method of a serving base station that may receive target base station information from the serving base station and may perform a handover.

2. Description of the Related Art

In a conventional broadband wireless access system, a single mobile communication apparatus communicates with a serving base station, namely a current base station, through a single band. In further developing the conventional broadband wireless access system, a scheme of performing communication between the mobile communication apparatus and the serving base station through a multi-band has been proposed. In other words, the mobile communication apparatus and the serving base station are designed to perform the communication using at least two bands.

Additionally, the mobile communication apparatus receives a broadcast service from the serving base station, and uses the received broadcast service. In the conventional broadband wireless access system, when a single band is used to perform communication between the mobile communication apparatus and the serving base station, a broadcast service may also be transmitted using the single band from the serving base station to the mobile communication apparatus. Conversely, when a multi-band is used to perform communication between the mobile communication apparatus and the serving base station, the serving base station may transmit the broadcast service to the mobile communication apparatus using at least one band.

In the conventional broadband wireless access system, both of a single band and a multi-band may exist. In such a communication environment, it is difficult to ensure the communication using the multi-band, when the mobile communication apparatus desires to move to another base station while receiving the broadcast service from the serving base station. Additionally, since all base stations provide different broadcast services, it is difficult to continue to receive the same broadcast service as the broadcast service received before moving to the other base station. Accordingly, there is a desire for a technology to ensure using of a multi-band and receiving a broadcast service when a mobile communication apparatus performs a handover.

### SUMMARY

An aspect of the present invention provides a mobile communication apparatus and a handover method of the mobile communication apparatus that may receive, prior to performing a handover, target base station information from a serving base station, and may perform a handover to a target base station corresponding to the received target base station information.

Another aspect of the present invention provides an information providing method of a serving base station that may collect, from a target base station, target base station information including band information and broadcast service providing information and may transmit the collected target base station information to a mobile communication apparatus, when a handover request signal is received from the mobile communication apparatus.

According to an aspect of the present invention, there is provided a mobile communication apparatus, including: an information receiver to receive, from a serving base station, target base station information corresponding to at least one target base station, the at least one target base station being located in a neighboring cell; and a controller to examine the target base station information, and to perform a handover to the at least one target base station based on whether the at least one target base station supports a multi-band, and whether the at least one target base station provides a broadcast service.

According to another aspect of the present invention, there is provided a handover method of a mobile communication apparatus in a broadband wireless access system, the handover method including: transmitting, prior to performing a handover, a handover request signal to a serving base station, the serving base station providing a broadcast service; receiving, target base station information corresponding to the handover request signal and corresponding to at least one target base station, the at least one target base station being located in a neighboring cell; and examining the target base station information, and performing a handover to the at least one target base station based on whether the at least one target base station supports a multi-band, and whether the at least one target base station provides a broadcast service.

According to still another aspect of the present invention, there is provided an information providing method of a serving base station in a broadband wireless access system, the information providing method including: receiving a handover request signal from a mobile communication apparatus; transmitting an information request signal to at least one target base station, the at least one target base station being located in a neighboring cell; collecting target base station information from the at least one target base station, the target base station information including band information and broadcast service providing information; and transmitting the target base station information to the mobile communication apparatus.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a broadband wireless access system according to an embodiment of the present invention;

FIG. 2 is a block diagram illustrating a configuration of a mobile communication apparatus of FIG. 1;

FIG. 3 is a flowchart illustrating a handover scheme according to an embodiment of the present invention; and

FIG. 4 is a flowchart illustrating a handover method of a mobile communication apparatus of FIG. 1.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

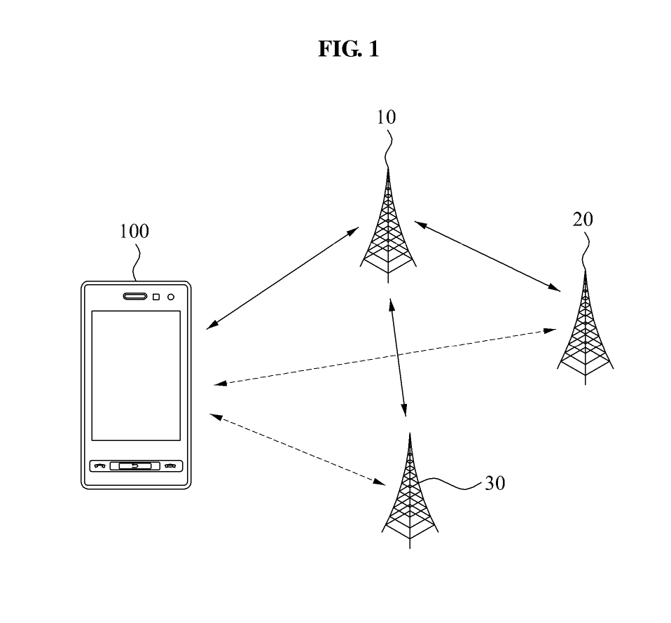

FIG. 1 is a diagram illustrating a broadband wireless access system according to an embodiment of the present invention. Referring to FIG. 1, the broadband wireless access system includes a mobile communication apparatus 100, a serving base station 10, a first target base station 20, and a second target base station 30. The serving base station 10 corresponds to a base station that currently provides a broadcast service to the mobile communication apparatus 100. Additionally, the first target base station 20 and the second target base station 30 may be located in a cell neighboring the serving base station 10, and may be targeted for use in a handover by the mobile communication apparatus 100. Hereinafter, it is assumed that the serving base station 10 and the first target base station 20 support a multi-band, and that the second target base station 30 supports a single band.

While only the first target base station 20 and the second target base station 30 are included in the cell neighboring the serving base station 10 as shown in FIG. 1, a greater number of target base stations may be included in the cell.

The mobile communication apparatus 100 may receive a broadcast service provided by the serving base station 10. The broadcast service may be transmitted downstream from the serving base station 10 to the mobile communication apparatus 100, however, may not be transmitted upstream from the mobile communication apparatus 100 to the serving base station 10.

The mobile communication apparatus 100 may communicate with the serving base station 10 using a multi-band. Specifically, the mobile communication apparatus 100 may designate several bands among multiple bands supported by the serving base station 10, and may communicate with the serving base station 10 using a multi-band scheme(*using the designated bands. Here, a number of bands designated by the mobile communication apparatus 100 may be changed based on a performance(*throughput of the mobile communication apparatus 100, for example a transmission rate of the mobile communication apparatus 100.

In one example, two bands may be used by the mobile communication apparatus 100, as shown in FIG. 1. One of the two bands is referred to as a Primary Component Carrier (PCC), and the other band is referred to as a Secondary Component Carrier (SCC). In another example, when at least two bands are used, one of the at least two bands may be referred to as a PCC, and the remaining bands may be referred to as SCCs.

When a broadcast service is currently being received from the serving base station 10, the mobile communication apparatus 100 may desirably perform a handover while continuing to communicate with the serving base station 10 using the multi-band. Accordingly, to obtain target base station information on the first target base station 20 and the second target base station 30 located in the neighboring cell, the mobile communication apparatus 100 may transmit a handover request signal to the serving base station 10. In response to the handover request signal, the serving base station 10 may communicate with the first target base station 20 and the second target base station 30, and may collect the target base station information on the first target base station 20 and the second target base station 30 from each of the first target base station 20 and the second target base station 30. Here, the target base station information may include identification information for each of the first target base station 20 and the second target base station 30, center frequency information for each of the first target base station 20 and the second target base station 30, information regarding whether a multi-band is supported for each of the first target base station 20 and the second target base station 30, and information regarding whether each of the first target base station 20 and the second target base station 30 provides a broadcast service.

The serving base station 10 may transmit the collected target base station information to the mobile communication apparatus 100. The mobile communication apparatus 100 may examine the received target base station information, and may determine either the first target base station 20 or the second target base station 30 as a handover target base station, based on whether each of the first target base station 20 and the second target base station 30 supports the multi-band, and whether each of the first target base station 20 and the second target base station 30 provides a broadcast service.

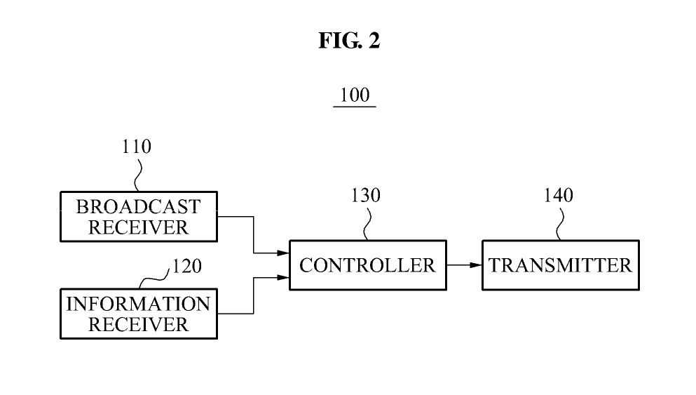

FIG. 2 is a block diagram illustrating a configuration of the mobile communication apparatus 100 of FIG. 1. Referring to FIG. 2, the mobile communication apparatus 100 includes a broadcast receiver 110, an information receiver 120, a controller 130, and a transmitter 140. The mobile communication apparatus 100 may be implemented as a portable communication apparatus, for example, a mobile phone or a Personal Digital Assistant (PDA).

The broadcast receiver 110 may receive a broadcast service provided by the serving base station 10.

The information receiver 120 may receive target base station information provided by the serving base station 10. Here, the target base station information may correspond to at least one target base station located in a cell neighboring the serving base station 10. Additionally, the target base station information may include identification information for each of the at least one target base station, center frequency information for each of the at least one target base station, information regarding whether a multi-band is supported for each of the at least one target base station, and information regarding whether each of the at least one target base station provides a broadcast service. For example, when a predetermined target base station supports a multi-band, the target base station information may include center frequency information regarding a center frequency of a PCC. Conversely, when the predetermined target base station supports a single band, the target base station information may include center frequency information regarding a center frequency of the single band.

The transmitter 140 may transmit a handover request signal to the serving base station 10.

The controller 130 may control a handover-related operation of the mobile communication apparatus 100. To perform a handover when the broadcast service is being received by the broadcast receiver 110, the controller 130 may control the transmitter 140 to transmit the handover request signal to the serving base station 10.

When target base station information corresponding to the handover request signal is received by the information receiver 120, the controller 130 may examine the target base station information, and may perform a handover to the at least one target base station based on whether the at least one target base station supports a multi-band, and whether the at least one target base station provides a broadcast service.

Specifically, the controller 130 may first designate a target base station supporting a multi-band among the at least one target base station, based on the target base station information, and may determine whether the designated target base station provides the broadcast service. For example, when the designated target base station provides the broadcast service, the controller 130 may set a center frequency of a PCC of the designated target base station, and may perform a handover to the designated target base station. In this example, the mobile communication apparatus 100 may use the identification information included in the target base station information, to perform the handover to the designated target base station.

Conversely, when the designated target base station does not provide the broadcast service, the controller 130 may terminate receiving of the broadcast service, and may perform the handover to the designated target base station. Here, when another target base station supporting the multi-band exists among the at least one target base station based on the target base station information, the controller 130 may determine whether the other target base station provides a broadcast service. As described above, the controller 130 may determine, in advance, which target base station supports a multi-band and provides a broadcast service, prior to performing a handover, and may perform the handover to the determined target base station.

When a target base station supporting the multi-band is determined not to exist among the at least one target base station, based on the target base station information received from the serving base station 10, the controller 130 may designate a target base station supporting a single band. Additionally, the controller 130 may determine whether the designated target base station provides a broadcast service. When the designated target base station provides the broadcast service, the controller 130 may set a center frequency of the single band of the designated target base station, and may perform a handover to the designated target base station. Accordingly, the controller 130 may more quickly perform a handover, by switching, in advance, from a multi-band communication mode to a single-band communication mode, even when there is no target base station supporting the multi-band.

Conversely, when the designated target base station does not provide the broadcast service, the controller 130 may terminate receiving of the broadcast service, and may perform the handover to the designated target base station. Here, when another target base station supporting a single band exists among the at least one target base station based on the target base station information, the controller 130 may determine whether the other target base station provides a broadcast service.

Alternatively, when receiving of a broadcast service is terminated since the broadcast service is not supported by target base stations, the controller 130 may notify a user of the termination of the receiving of the broadcast service, prior to performing a handover.

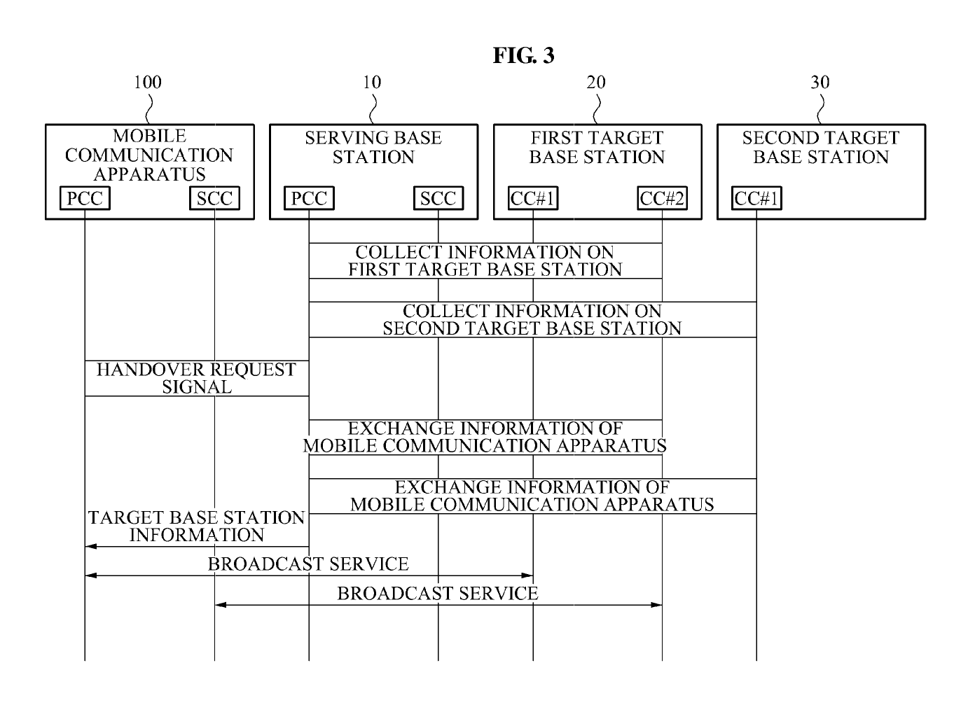

FIG. 3 is a diagram illustrating a handover scheme according to an embodiment of the present invention. The handover scheme of FIG. 3 may be performed among the mobile communication apparatus 100, the serving base station 10, the first target base station 20, and the second target base station 30.

The serving base station 10 may collect target base station information from the first target base station 20 and the second target base station 30, by exchanging various information with the first target base station 20 and the second target base station 30. Here, the collecting operation may be performed before a handover request signal is received from the mobile communication apparatus 100.

Subsequently, when the mobile communication apparatus 100 transmits the handover request signal to the serving base station 10, the serving base station 10 may exchange information of the mobile communication apparatus 100 with the first target base station 20 and the second target base station 30. Additionally, the serving base station 10 may transmit the target base station information collected from the first target base station 20 and the second target base station 30 to the mobile communication apparatus 100 that is to perform a handover.

The mobile communication apparatus 100 may first designate the first target base station 20 supporting a multi-band based on the collected target base station information, and may determine whether the first target base station 20 provides a broadcast service. When the first target base station 20 provides the broadcast service, the mobile communication apparatus 100 may perform a handover to the first target base station 20, and may set the first target base station 20 as a serving base station. In other words, the mobile communication apparatus 100 may receive the broadcast service provided by the first target base station 20.

When failing to collect the target base station information on the first target base station 20, the mobile communication apparatus 100 may designate the second target base station 30 supporting a single band, and may determine whether the second target base station 30 provides a broadcast service. When the second target base station 30 provides the broadcast service, the mobile communication apparatus 100 may perform a handover to the second target base station 30, and may set the second target base station 30 as a serving base station. In other words, the mobile communication apparatus 100 may receive the broadcast service provided by the second target base station 30.

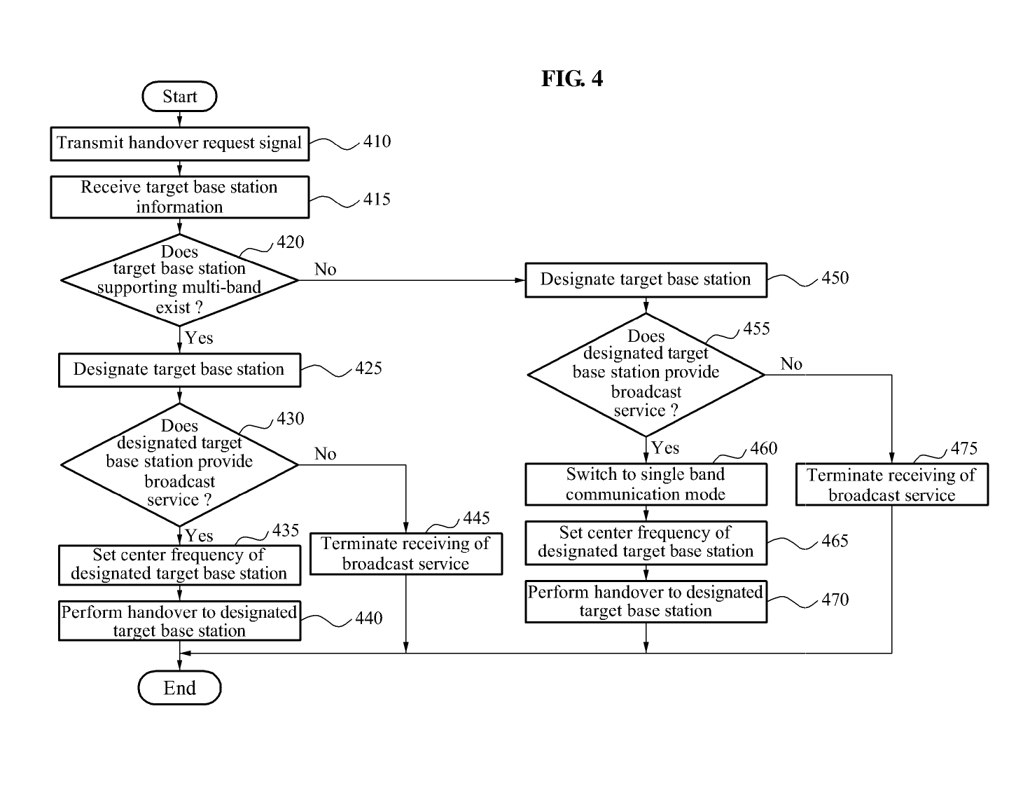

FIG. 4 is a flowchart illustrating a handover method of the mobile communication apparatus 100. Referring to FIG. 4, to perform a handover, the mobile communication apparatus 100 may transmit a handover request signal to a serving base station that currently provides a broadcast service in operation 410.

In operation 415, the mobile communication apparatus 100 may receive target base station information corresponding to the handover request signal from a serving base station. Here, the target base station information may be associated with at least one target base station that is located in a communication cell neighboring the serving base station. Additionally, the target base station information may include identification information for each of the at least one target base station, center frequency information for each of the at least one target base station, information regarding whether a multi-band is supported for each of the at least one target base station, and information regarding whether each of the at least one target base station provides a broadcast service.

In operation 420, the mobile communication apparatus 100 may determine whether a target base station supporting a multi-band exists among the at least one target base station, based on the target base station information. When the target base station supporting the multi-band is determined to exist in operation 420, the mobile communication apparatus 100 may designate the target base station in operation 425. Here, when a plurality of target base stations support the multi-band, the mobile communication apparatus 100 may optionally designate one of the plurality of target base stations.

In operation 430, the mobile communication apparatus 100 may determine whether the designated target base station provides a broadcast service. When the designated target base station provides the broadcast service, the mobile communication apparatus 100 may set a center frequency of the designated target base station in operation 435. Here, since the designated target base station supports the multi-band, the center frequency of the designated target base station may be used as a center frequency of a PCC. In operation 440, the mobile communication apparatus 100 may perform a handover to the designated target base station.

Conversely, when the designated target base station does not provide the broadcast service in operation 430, the mobile communication apparatus 100 may terminate receiving of the broadcast service in operation 445. Additionally, the mobile communication apparatus 100 may perform the handover to the designated target base station, even when the receiving of the broadcast service is terminated.

When the target base station supporting the multi-band is determined not to exist in operation 420, the mobile communication apparatus 100 may designate a target base station supporting a single band in operation 450.

In operation 455, the mobile communication apparatus 100 may determine whether the designated target base station provides a broadcast service. When the designated target base station provides the broadcast service in operation 455, the mobile communication apparatus 100 may switch from a multi-band communication mode to a single-band communication mode in operation 460. The mobile communication apparatus 100 may set a center frequency of the designated target base station in operation 465, and may perform a handover to the designated target base station in operation 470.

Conversely, when the designated target base station does not provide the broadcast service in operation 455, the mobile communication apparatus 100 may terminate receiving of the broadcast service in operation 475. The mobile communication apparatus 100 may perform the handover to the designated target base station even when the receiving of the broadcast service is terminated.

As described above, the mobile communication apparatus 100 may receive the target base station information from the serving base station, prior to performing a handover, and may first search for a target base station that supports a multi-band and provides a broadcast service, thereby performing a handover to the target base station.

According to embodiments of the present invention, a mobile communication apparatus may determine, in advance, which target base station supports a multi-band, by receiving, from a serving base station, target base station information corresponding to at least one target base station located in a neighboring cell, prior to performing a handover. Additionally, the mobile communication apparatus may recognize, in advance, which base station provides a broadcast service among the at least one target base station, based on the target base station information.

Accordingly, a target base station may be designated in advance prior to performing a handover, and the handover to the designated target base station may be performed. Thus, it is possible to quickly and easily perform a handover, without a need to switch a communication mode or a service mode.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A mobile communication apparatus, comprising:
an information receiver to receive, from a serving base station, target base station information corresponding to at least one target base station, the at least one target base station being located in a neighboring cell; and
a controller to examine the target base station information, and to perform a handover to the at least one target base station based on whether the at least one target base station supports a multi-band, and whether the at least one target base station provides a broadcast service.

2. The mobile communication apparatus of claim 1, wherein the controller first designates a target base station supporting a multi-band among the at least one target base station, based on the target base station information, and
wherein the controller sets a center frequency of a Primary Component Carrier (PCC) of the designated target base station, and performs a handover to the designated target base station, when the designated target base station provides a broadcast service.

3. The mobile communication apparatus of claim 2, wherein the controller terminates receiving of the broadcast service, when the designated target base station does not provide the broadcast service.

4. The mobile communication apparatus of claim 1, wherein the controller designates a target base station supporting a single band, when a target base station supporting a multi-band does not exist among the at least one target base station, and
wherein the controller sets a center frequency of the designated target base station, and performs a handover to the designated target base station, when the designated target base station provides a broadcast service.

5. The mobile communication apparatus of claim 4, wherein the controller terminates receiving of the broadcast service, when the designated target base station does not provide the broadcast service.

6. The mobile communication apparatus of claim 1, wherein the target base station information comprises identification information for each of the at least one target base station, center frequency information for each of the at least one target base station, information regarding whether a multi-band is supported for each of the at least one target base station, and information regarding whether each of the at least one target base station provides a broadcast service.

7. A handover method of a mobile communication apparatus in a broadband wireless access system, the handover method comprising:
transmitting, prior to performing a handover, a handover request signal to a serving base station, the serving base station providing a broadcast service;
receiving target base station information corresponding to the handover request signal and corresponding to at least one target base station, the at least one target base station being located in a neighboring cell; and
examining the target base station information, and performing a handover to the at least one target base station based on whether the at least one target base station supports a multi-band, and whether the at least one target base station provides a broadcast service.

8. The handover method of claim 7, wherein the examining comprises:
first designating a target base station supporting a multi-band among the at least one target base station based on the target base station information;
determining whether the designated target base station provides a broadcast service;
setting a center frequency of a PCC of the designated target base station, when the designated target base station provides the broadcast service; and
performing a handover to the designated target base station.

9. The handover method of claim 8, wherein the examining further comprises:
terminating receiving of the broadcast service, when the designated target base station does not provide the broadcast service.

10. The handover method of claim 7, wherein the examining comprises:
designating a target base station supporting a single band, when a target base station supporting a multi-band does not exist among the at least one target base station;
determining whether the designated target base station provides a broadcast service;
setting a center frequency of the designated target base station, when the designated target base station provides the broadcast service; and
performing a handover to the designated target base station.

11. The handover method of claim 10, wherein the examining further comprises:
terminating receiving of the broadcast service, when the designated target base station does not provide the broadcast service.

12. The handover method of claim 7, wherein the target base station information comprises identification information for each of the at least one target base station, center frequency information for each of the at least one target base station, information regarding whether a multi-band is supported for each of the at least one target base station, and information regarding whether each of the at least one target base station provides a broadcast service.

13. An information providing method of a serving base station in a broadband wireless access system, the information providing method comprising:
receiving a handover request signal from a mobile communication apparatus;
transmitting an information request signal to at least one target base station, the at least one target base station being located in a neighboring cell;
collecting target base station information from the at least one target base station, the target base station information comprising band information and broadcast service providing information; and
transmitting the target base station information to the mobile communication apparatus.
